(19) United States
(12) Patent Application Publication
(10) Pub. No.: US 2010/0191768 A1
(43) Pub. Date: Jul. 29, 2010

(54) SEARCH QUERY CATEGORIZATION FOR BUSINESS LISTINGS SEARCH

(75) Inventors: Radhika MALPANI, Palo Alto, CA (US); Vibhu MITTAL, Sunnyvale, CA (US)

Correspondence Address: HARRITY & HARRITY, LLP, 11350 Random Hills Road, SUITE 600, FAIRFAX, VA, 22030, US

(73) Assignee: GOOGLE INC., Mountain View, CA (US)

(21) Appl. No.: 12/756,580

(22) Filed: Apr. 8, 2010

Related U.S. Application Data
(63) Continuation of application No. 10/462,818, filed on Jun. 17, 2003.

(51) Int. Cl. G06F 17/30

(52) U.S. Cl. 707/771; 707/E17.014; 707/E17.044

(57) ABSTRACT

A category classification component locates appropriate categories that apply to a user search query. The categories may be yellow page business listings. The category classification component may include a category model that is automatically trained on one or more of a number of possible training data sources. The training data sources may include directory listings, web documents, query traffic, and advertisement traffic.

### BACKGROUND OF THE INVENTION

A. Field of the Invention

The present invention relates generally to text classification, and more particularly, to determining yellow page categories corresponding to a user query.

B. Description of Related Art

Existing on-line yellow page offerings return business names based on a user search query. Conventionally, terms in the search query are matched to business names to generate relevant results for the user. Thus, for example, the search query “pizza” may result in the businesses “Pizza Hut” and “Round Table Pizza” but not pizza restaurants that don't include the term “pizza,” such as “Pappa John's”.

In returning business names, a category match may also be performed. The category match may be displayed to the user and may be used to refine the returned business names. For example, for the search query “pizzeria,” the category “pizzeria restaurants” may be located based on a matching of the search term “pizzeria” to the same word in the category name. A search for “pizzeria,” however, may not return the general category “restaurants” if the query does not contain the term “restaurants.” This can be problematic, as it is important to be able to match a search such as “film development” to the category “photo finishing” even though the category and the search terms do not have any words in common.

In an attempt to avoid the above-discussed problem of not returning the correct category, existing techniques for matching categories to a search query may count a category as a match if any term in the user's query matches any word in the category name. However, this technique does not cover many situations and can lead to poor categorization.

Another existing technique for category matching uses synonyms to augment the category names or the user search queries. The synonyms may come from a pre-existing list of synonyms. Using synonyms is not optimal, however, because category names can be idiosyncratic and do not always correspond to conventional synonym lists. For example, the term “film” can have different meaning in different contexts. For example, “film” can refer to theaters, photographic film, or chemical laboratory equipment.

Thus, there is a need to more effectively classify search queries into one or more appropriate business category listings.

### SUMMARY OF THE INVENTION

A search query categorization technique consistent with principles of the invention automatically builds a category classification model based on training data. The training data may be derived from a number of possible sources.

One aspect of the invention is directed to a method for generating business categories relevant to a search query. The method includes receiving the search query from a user and inputting the search query to a classification component. The classification component includes a category model that is trained with training data from one or more sources of information that relate terms to business categories. The method further includes receiving one or more categories from the classification component in response to the input search query and transmitting the one or more categories to the user.

Another aspect of the invention is directed to a category classification device that includes a category classification component that implements a statistical model that associates search queries to business categories relevant to the search queries. The category classification component can operate in a first mode in which the category classification component learns the associations between the search queries and the business categories based on training data and in a second mode in which the category classification component generates relevant business categories in response to input search queries. Further, a category model stores the associations between the search queries and the business categories as a set of probabilities. The category model is constructed based on training data selected from at least one of predefined yellow page listings, categorized business web sites, consumer reports information, restaurant guides, query traffic data, and advertisement traffic data.

Yet another aspect of the invention is directed to a computing device that includes a processor and a memory coupled to the processor. The memory includes a category classification program that further includes a category classification component and a category model. The category classification component implements a statistical model that associates search queries to business categories relevant to the search queries. The category classification component operates in a first mode in which the category classification component learns the associations between the search queries and the business categories based on training data and in a second mode in which the category classification component generates relevant business categories in response to input search queries. The category model stores the associations between the search queries and the business categories as a set of probabilities. The category model is constructed based on training data selected from at least one of predefined yellow page listings, categorized business web sites, consumer reports information, restaurant guides, query traffic data, and advertisement traffic data.

Yet another aspect consistent with the invention is directed to a method of training a model to associate categories with search queries. The method includes receiving training data as a set of category entries each associated with a search query, where each search query is represented by one or more search terms. The method further includes automatically generating a statistical based category model based on the training data as a set of values that define probabilities of the search terms being associated with particular ones of the category entries.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram illustrating an exemplary system in which concepts consistent with the present invention may be implemented;

FIG. 2 is a diagram illustrating results of an exemplary category search performed by a user;

FIG. 3 is a conceptual diagram illustrating training of the classification component shown in FIG. 1;

FIG. 4 is a diagram illustrating a portion of exemplary training data obtained from a directory listing; and

FIG. 5 is a flow chart illustrating operation of the classification component consistent with an aspect of the invention.

### DETAILED DESCRIPTION

The following detailed description of the invention refers to the accompanying drawings. The same reference numbers in different drawings may identify the same elements. The detailed description does not limit the invention. Instead, the scope of the invention is defined by the appended claims and equivalents.

As described herein, according to one aspect of the invention a classification component matches search queries to listings of business categories using a textual classification model. The classification component may be automatically trained from one or more of a number of sources, including directory listings, web documents, query traffic, and advertisement traffic. In one embodiment, the classification may be based on a naïve Bayes classification.

### System Overview

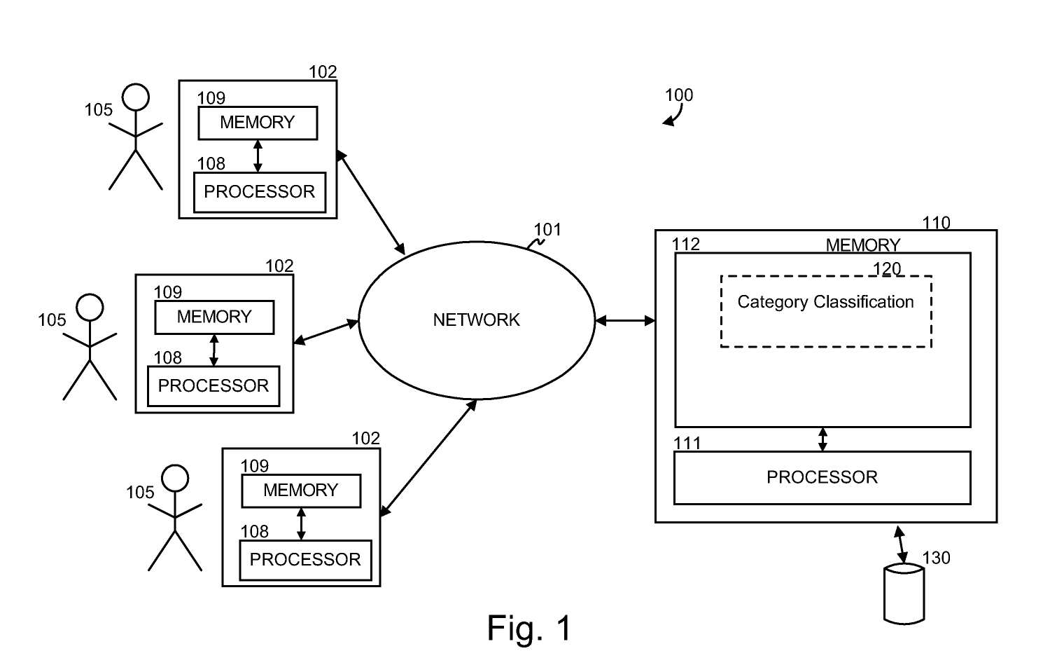

FIG. 1 is a diagram illustrating an exemplary system 100 in which concepts consistent with the present invention may be implemented. System 100 includes multiple client devices 102, a server device 110, and a network 101, which may be, for example, the Internet. Client devices 102 each includes a computer-readable memory 109, such as random access memory, coupled to a processor 108. Processor 108 executes program instructions stored in memory 109. Client devices 102 may also include a number of additional external or internal devices, such as, without limitation, a mouse, a CD-ROM, a keyboard, and a display.

Through client devices 102, users 105 can communicate over network 101 with each other and with other systems and devices coupled to network 101, such as server device 110. In general, client device 102 may be any type of computing platform connected to a network and that interacts with application programs, such as a digital assistant or a “smart” cellular telephone or pager.

Similar to client devices 102, server device 110 may include a processor 111 coupled to a computer-readable memory 112. Server device 110 may additionally include a secondary storage element, such as database 130.

Client processors 108 and server processor 111 can be any of a number of well known computer processors. Server 110, although depicted as a single computer system, may be implemented as a network of computer processors.

Memory 112 may contain a category classification component 120. Category classification component 120 returns categories, such as business categories similar to those in yellow pages listings, based on user search queries. In particular, users 105 may send search queries to server device 110, which responds by returning one or more relevant categories to user 105 based on the terms (i.e., words) in the search query. In some implementations, a database 130 may be used by server device 110 to store classification models used by classification component 120.

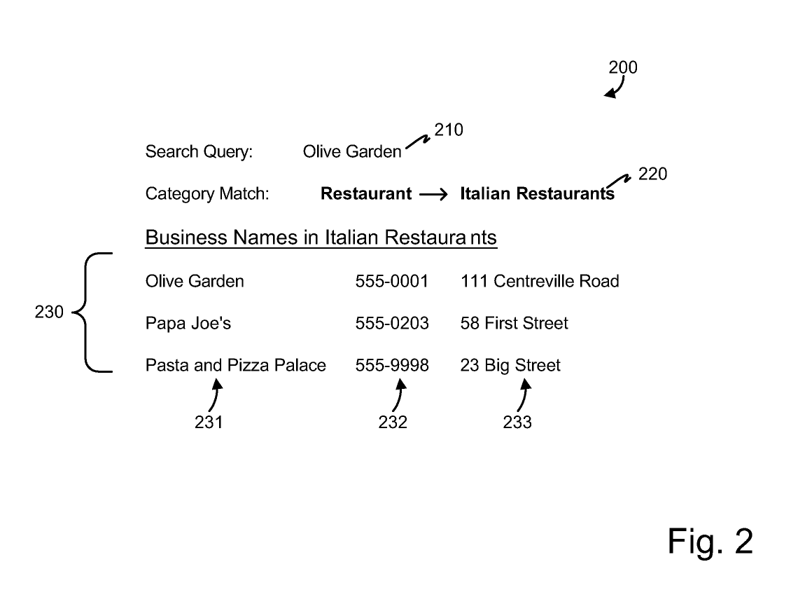

FIG. 2 is a diagram illustrating results of an exemplary category search performed by one of users 105. Results page 200 may be generated by server device 110 using category classification component 120. The results may be transmitted to the user 105 as, for example, a hyper-text markup language (HTML) document that the user can view with a conventional web browser program.

Result page 200 may display the search query 210 that the user requested. In this example, the user entered “Olive Garden,” the name of an Italian restaurant. Page 200 may display a category 220 that lists the category that category classification component 120 determined to be the most likely matching category. In this example, the main category “Restaurants” and the sub-category “Italian restaurants” were returned. In other implementations, multiple potential categories may be shown to the user.

Below category list 220, a number of specific businesses 230 are shown. Businesses 230 may be businesses listed under the sub-category “Italian Restaurants.” In some implementations, businesses that are not in category 220 but that closely match search query 210 may also be listed. In this example, three Italian restaurants 231 are listed, along with corresponding phone numbers 232 and addresses 233.

### Classification Component 120

Classification component 120 implements a statistical model that, based on training data, automatically learns associations between categories and search queries. Classification component 120 may operate in one of two main modes: a training mode and a run-time classification mode. In the training mode, classification component 120 receives training data that includes exemplary search queries associated with their correct corresponding categories. Based on this training data, classification component 120 learns the associations between the categories and the search queries. In the run-time mode, classification component 120 receives user search queries and returns one or more categories. The returned categories are based on the learned associations and may be categories that are generalized based on search queries that were not explicitly present in the training data.

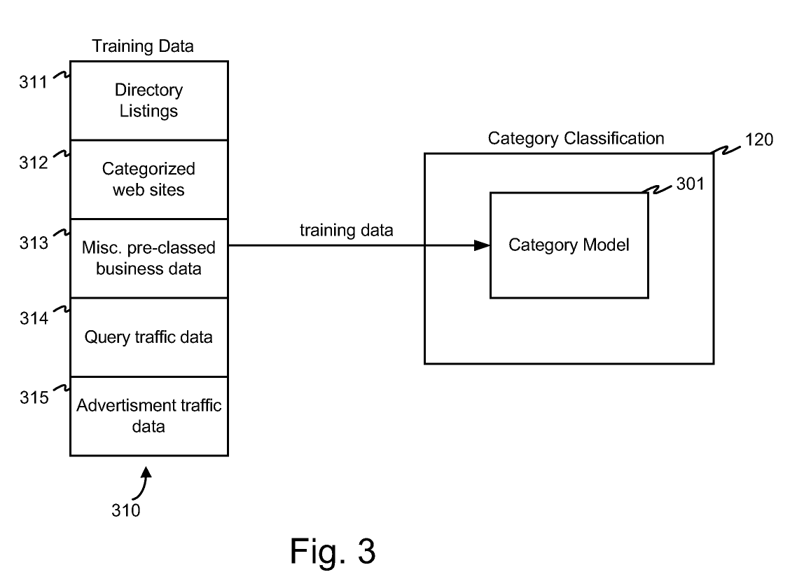

FIG. 3 is a conceptual diagram illustrating training of classification component 120. When training, classification component 120 builds a category model 301 that relates search queries to categories. Category model 301 may be built based on category/search query associations derived from one or more of a number of possible training data sources 310.

Classification component 120 acts as a textual classifier to associate textual search queries to predefined categories. A number of textual classifiers are known in the art and could be used to implement classification component 120. One appropriate category of textual classification models are models based on the naïve Bayes assumptions.

A naïve Bayes classifier is a statistical classifier based on Bayes' theorem, which may be given by

$$P [ {X}_{i} \vert Y ] = \frac{P [ Y \vert {X}_{i} ] \cdot P [ {X}_{i} ]}{{\sum }_{j} P [ Y \vert {X}_{j} ] \cdot P [ {X}_{j} ]} . \qquad ( 1 )$$

In equation (1), Xᵢ represents the N possible classes (categories), where the integer i is in [1, N]. Y represents an event, such as a search query, that is to be classified into an appropriate category Xᵢ. Equation (1) thus gives the conditional probability of a particular category X given a search query Y. A particular search query Y may be made up of a number of attributes (i.e., search terms).

The probabilities on the right-hand side of equation (1) may be stored in category model 301 during training P[Xᵢ], which represents the probability that category Xᵢ occurs, may, for example, be estimated by counting the training samples that fall into Xᵢ and dividing by the size of the training set. P[Y|Xᵢ] may be estimated using the naive Bayes assumption that assumes (potentially unjustifiably) that the attribute values of Y are independent. For example, if Y has the attributes “olive” and “garden”, classification component 120 may estimate P[Y|Xᵢ] as P[“olive”|Xᵢ]·P[“garden”|Xᵢ]. Category model 301 may thus store P[“olive”|Xᵢ] and P[“garden”|Xᵢ]. These probabilities may be estimated for any particular term by, for example, counting the number of occurrences of the term in a particular category and dividing by the total number of occurrences of the term across all i categories.

Because the denominator in equation (1) is independent of i (and is always nonnegative), the most likely category, Xᵢ, for a particular search query, Y, will correspond to the greatest magnitude numerator. Thus, to perform a category classification, classification component 120 need only compute the numerator in equation (1) for each Xᵢ and then pick the Xᵢ having the largest value.

A naïve Bayes-based classifier, as discussed above, models the probability of a search query belonging to a particular category based on the probability of the category, P[Xᵢ], and the independent probability of each term in the search query given the particular category (e.g., P[“olive”|Xᵢ]). These probabilities may be derived based on training data 310 and stored in category model 301. One of ordinary skill in the art will recognize that other textual classification models, instead of the simple naïve Bayes-based classifier described above, may alternatively be used to implement classification component 120. A common theme among each of these textual classification models is that they must be trained.

Consistent with an aspect of the invention, training data 310 may be derived from one or more sources. As shown in FIG. 3, training data sources 310 may include directory listings 311, categorized web sites 312, miscellaneous pre-classified business data 313, query traffic data 314, and advertisement traffic data 315.

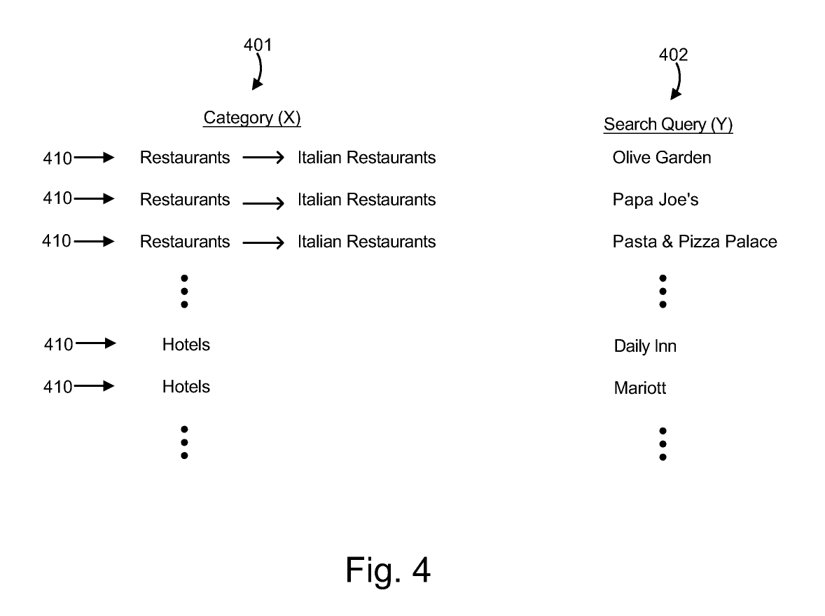

Directory listings 311 may include yellow page directory listings, such as those compiled by various phone companies. Such directory listings 311 may include business categories as well as business names associated with each of the business categories. FIG. 4 is a diagram illustrating a portion of exemplary training data obtained from a directory listing 311. As shown, each training entry 410 includes a category 401 and an associated search query 402. In this example, the terms for each search query 402 are defined as the words in the business name from directory listing 311. Thus, from directory listing 311, training data entries 410 may be generated as a series of business categories and associated business names.

In the context of a naïve Bayes classifier, the independent probabilities, P[Xᵢ], of a category may be estimated as the number of training entries 410 in the category divided by the total number of entries 410. The probability of a particular term in a search query 402 may be estimated as the number of occurrences of that term in the particular category divided by the total number of occurrences of the term in all of the training entries 410.

Categorized web sites 312 may include web sites for businesses with a known categorization. For example, assume that company XYZ has a corporate web site. The web site may include information about the company, such as the products or services that the company produces or is engaged in. Further, assume that the correct categorization of company XYZ is known from, for example, a listing in directory listings 311.

During training, classification component 120 may add terms to or modify the probabilities in category model 301 based on categorized web sites 312. In particular, terms in the corporate web site may be used to modify the probabilities stored in category model 301. For example, the probability of a particular term, Y′, given the category of business XYZ, P[Y′|“XYZ”], may be modified in category model 301 based on the occurrences of Y′ in the corporate web site.

In one implementation, terms that tend to occur less frequently may be given more weight when modifying category model 301 based on categorized web sites 312. The inverse document frequency (idf) is one example of a function that may be used to quantify how frequently a term occurs. The idf of a term may be defined as a function of the number f of documents in a collection in which the term occurs and the number J of documents in the collection. In the context of a web document, such as a web page, the collection may refer to the set or a subset of the available web pages. More specifically, one definition for the idf may be as log

$$( \frac{J}{f + 1} ) .$$

However, in general, any function g(x) may be used, where g(x) preferably is convex and monotonically decreasing for increasing values of x. Higher idf values indicate that a term is relatively more important than a term with a lower idf value. Thus, for example, if a term in the corporate web site, Y′, has a relatively high idf value, the corresponding probability P[Y′|Xᵢ] in category model 301 may be modified to reflect the increased probability that the term Y′ is associated with category Xᵢ.

Miscellaneous pre-classified business data 313 may include other sources of pre-classified business data, such as consumer reports information, restaurant guides, or web-based directory listings. Miscellaneous pre-classified business data 313 may be used to modify category model 301 in a manner similar to categorized web sites 312. That is, the miscellaneous pre-classified business data 313 may be considered to be one or more documents containing words that are associated with a category Xᵢ. The words can be used to modify the probabilities P[Y′|Xᵢ] in category model 301 based on the idf of the words.

Query traffic data 314 may include training data taken from user interaction with classification component 120. Query traffic data 314 may be used by classification component 120 to infer likelihoods of various senses of ambiguous terms. For example, assume that a user enters the search query “films” and receives back a number of business listings, including some listings that that are in the “theater” category and some listings that are in the “photographic film” category. The user may then select one of the listings corresponding to the “photographic film” category. In this situation, classification component 120 may modify the probabilities P[Y′|Xᵢ], in which Y′ corresponds to “films” to indicate that the probability associated with the category Xᵢ in which i indicates photographic film is more likely than the category Xᵢ in which i indicates theater.

Advertisement traffic data 315 may include training data taken from user interaction with advertisements. It is common for commercial search engines to display advertisements to a user along with the results of the user query. In order to make the advertisements more relevant to the user, the advertisements may be selected based on the user query. A user selecting a displayed advertisement may indicate that the advertisement was relevant to the search query. Thus, the search query and the category of the selected advertisement may be considered training data that can be used to modify or initially train category model 301 in a manner similar to the training performed for query traffic data 314.

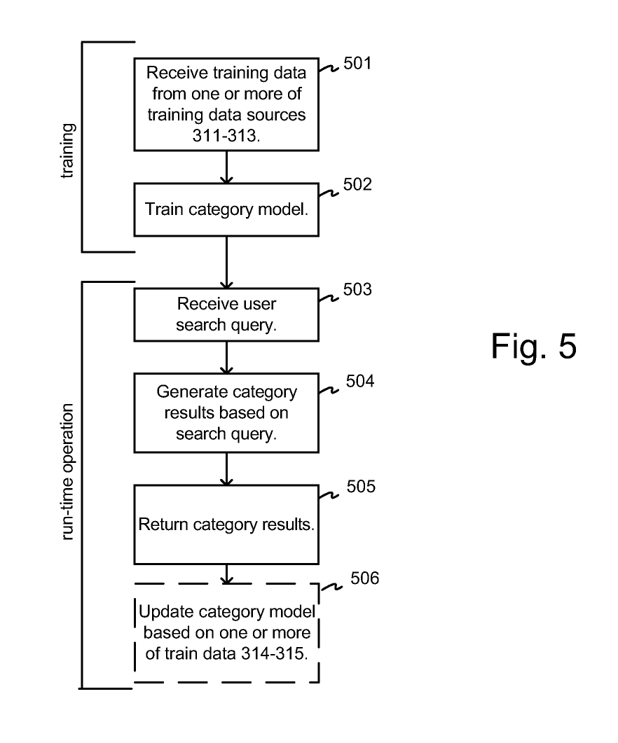

FIG. 5 is a flow chart illustrating operation of classification component 120 consistent with an aspect of the invention. Classification component 120 may begin by receiving training data from one or more of sources 311-313 (Act 501) and training category model 301 based on this training data (Act 502). In this manner, a solution to a classification problem is achieved through an automated and supervised learning process. In one implementation, classification component 120 may use naïve Bayes-based textual classification techniques for the supervised training of category model 301. One of ordinary skill in the art will recognize that other classification techniques may alternatively be used.

In one embodiment of the invention, after training classification component 120 may operate in its run-time classification mode. Classification component 120 may receive user search queries (Act 503). Classification component 120 may then, based on values stored in category model 301, determine the most likely categories associated with the user search queries (Act 504). As discussed previously, the search query may include one or more words that may be evaluated using equation (1) to determine the likelihood of the search query corresponding to each of the possible categories Xᵢ. As an example of a possible category classification performed by classification component 120, the word “garden” by itself may have a likelihood of 0.5 of belonging to the category “Home & Garden,” a likelihood of 0.8 of belonging to the category “Recreation & Parks,” and a likelihood of 0.1 of belonging to the category “Restaurants.” Taken together with the word “olive,” however, the likelihoods may be 0.01 for “Home & Garden,” 0.001 for “Recreation & Parks,” and 0.05 for “Italian Restaurants.” Thus, the combined likelihood is highest for Italian Restaurants.

The categories generated by category classification component 120 may be returned to the user over network 101 (Act 505). As previously mentioned, in some implementations, category classification component 120 may dynamically update category model 301 based on run-time training data such as query traffic data 314 and/or advertisement traffic data 315 (Act 506).

### Conclusion

As describe above, classification component 120 intelligently associates search queries with categories, such as categories of listings. Their associations may be based on a category model that can be automatically trained from a number of different sources of training data.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code—it being understood that a person of ordinary skill in the art would be able to design software and control hardware to implement the aspects based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

1. A method for identifying categories relevant to a search query, the method comprising:
receiving the search query;
inputting the search query to a classification component that includes a category model trained with training data from one or more sources of information that relate terms to categories;
receiving one or more categories from the classification component in response to the search query; and
transmitting the one or more categories.

2-32. (canceled)
